(19) United States
(12) Patent Application Publication
(10) Pub. No.: US 2016/0115294 A1
(43) Pub. Date: Apr. 28, 2016

(54) CURATIVE COMPOSITIONS, FLUOROPOLYMER COMPOSITIONS, AND METHODS

(71) Applicant: 3M INNOVATIVE PROPERTIES COMPANY, Saint Paul, MN (US)

(72) Inventor: Werner M.A. Grootaert, Oakdale, MN (US)

(21) Appl. No.: 14/897,155

(22) PCT Filed: Jun. 11, 2014
(86) PCT No.: PCT/US2014/041949

§ 371 Date: Dec. 9, 2015

Related U.S. Application Data
(60) Provisional application No. 61/834,612, filed on Jun. 13, 2013.

(51) Int. Cl. C08K 5/00; C08K 3/04; C08J 7/12; C08K 5/50; C08J 3/24; C08K 3/36; C08K 5/19

(52) U.S. Cl. CPC C08K 5/0025; C08K 3/36; C08K 3/04; C08K 5/19; C08K 5/50; C08J 3/24; C08J 7/12; C08J 2327/12

(57) ABSTRACT

A curative composition includes a tetraalkylphosphonium or tetraalkylammonium cation and an anion represented by Formula (Rf)₃CO⁻, wherein each Rf is independently perfluoroalkyl having up to 12 carbon atoms. A fluoropolymer composition includes the curative composition and a fluoropolymer. The fluoropolymer can be an amorphous, curable fluoropolymer with nitrogen-containing cure sites. Shaped articles including the fluoropolymer, a method of making a fluoroelastomer article, and a method of making the curative composition are also described.

### CROSS-REFERENCE TO RELATED APPLICATION

This application claims priority to U.S. Application No. 61/834,612, filed Jun. 13, 2013, the disclosure of which is incorporated by reference in its entirety herein.

### BACKGROUND

Fluoroelastomers are known to have excellent mechanical properties, heat resistance, weather resistance, and chemical resistance, for example. Such beneficial properties render fluoroelastomers useful, for example, as O-rings, seals, hoses, skid materials, and coatings (e.g., metal gasket coating for automobiles) that may be exposed to elevated temperatures or corrosive environments. Fluoroelastomers have been found useful in the automotive, chemical processing, semiconductor, aerospace, and petroleum industries, among others.

Fluoroelastomers are typically prepared by combining an amorphous fluoropolymer, sometimes referred to as a fluoroelastomer gum, with one or more curatives, shaping the resulting curable composition into a desired shape, and curing the curable composition. The amorphous fluoropolymer often includes a cure site, which is a functional group incorporated into the amorphous fluoropolymer backbone capable of reacting with a certain curative. Certain fluoroalkoxy onium catalysts have been demonstrated to be useful for curing amorphous fluoropolymers having nitrogen-containing cure sites. See, for example, U.S. Pat. Nos. 7,989,552 and 7,294,677 (both to Grootaert et al.) and Int. Pat. Appl. Pub. No. WO2010/151610 (Grootaert et al.).

### SUMMARY

The present disclosure provides a curative composition useful, for example, for curing nitrogen-containing, amorphous fluoropolymers into fluoroelastomers. The curative compositions include at least one of tetraalkylphosphonium or tetraalkylammonium cations and perfluorinated tertiary alkoxide anions. While the fluoroalkoxy onium catalysts described above, such as phosphonium 2-aryl-1,1,1,3,3,3-hexafluoroisopropoxides, have been shown to be useful for curing nitrogen-containing, amorphous fluoropolymers to provide fluoroelastomers with desirable compression set, in certain processes, incompatibility of the catalyst within the amorphous fluoropolymer has been observed. Such incompatibility can cause the catalyst to bloom to the surface under some circumstances and may cause mold fouling in some molding processes. The curative compositions according to the present disclosure have perfluorinated tertiary alkoxide anions and have not been observed to have such incompatibility problems. Unexpectedly, fluoroelastomers prepared from curative compositions according to the present disclosure have even better compression set than those prepared from a tetraalkyl phosphonium or ammonium 2-aryl-1,1,1,3,3,3-hexafluoroisopropoxide.

In one aspect, the present disclosure provides a curative composition including a tetraalkylphosphonium or tetraalkylammonium cation and an anion represented by Formula (Rf)₃C0⁻, wherein each Rf is independently perfluoroalkyl having up to 12 carbon atoms. In some embodiments, each Rf is independently perfluoroalkyl having up to 4 carbon atoms. In some embodiments, each Rf is perfluoromethyl. In some embodiments, the tetraalkylphosphonium cation is tetrabutylphosphonium, and the tetraalkylammonium cation is tetramethylammonium. In some embodiments, the curative composition includes tetramethylammonium perfluoro-tert-butoxide. In some embodiments, the curative composition includes tetrabutylphosphonium perfluoro-tert-butoxide.

In another aspect, the present disclosure provides a fluoropolymer composition including the curative composition disclosed herein and a fluoropolymer. In some embodiments, the fluoropolymer is an amorphous, curable fluoropolymer with nitrogen-containing cure sites, which may be nitrile cure sites.

In another aspect, the present disclosure provides a shaped article including the fluoropolymer composition.

In another aspect, the present disclosure provides a method of making a fluoroelastomer article. The method includes providing the fluoropolymer composition disclosed herein, shaping the fluoropolymer composition, and crosslinking the fluorpolymer composition to form the fluoroelastomer article.

In another aspect, the present disclosure provides a method of making the curative composition disclosed herein. The method includes making the cation and the anion by combining an alcohol represented by formula (Rf)₃COH and a tetraalkyl phosphonium hydroxide or a tetraalkylammonium hydroxide or combining an alcohol represented by formula (Rf)₃COH, a base, and a tetraalkylphosphonium halide or a tetraalkylammonium halide.

In this application:

Terms such as “a”, “an” and “the” are not intended to refer to only a singular entity, but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list. “Alkyl group” and the prefix “alk-” are inclusive of both straight chain and branched chain groups and of cyclic groups having up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms.

The term “perfluoroalkyl group” includes linear, branched, and/or cyclic alkyl groups in which all C—H bonds are replaced by C—F bonds.

The terms “cure” and “curable” joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility, but may be swellable in the presence of an appropriate solvent. All numerical ranges are inclusive of their endpoints and nonintegral values between the endpoints unless otherwise stated.

### DETAILED DESCRIPTION

The curative composition according to the present disclosure includes an anion represented by Formula (Rf)₃C-O⁻, in which each Rf is independently perfluoroalkyl having up to 12 carbon atoms. In some embodiments, each Rf is independently perfluoroalkyl having up to 11, 10, 9, 8, 7, 6, 5, 4, 3, or 2 carbon atoms. In some embodiments, at least one Rf is perfluoromethyl. In some embodiments, two of the Rf groups are perfluoromethyl, and the other Rf group is perfluoroalkyl having up to 12, 11, 10, 9, 8, 7, 6, 5, 4, 3, or 2 carbon atoms. In some embodiments, each Rf is perfluoromethyl. The curative composition according to the present disclosure further includes a tetraalkylphosphonium or a tetraalkylammonium cation. In the tetralkylphosphonium or tetraalkylammonium cation, each alkyl independently has up to 12 carbon atoms. In some embodiments, each alkyl independently has up to 11, 10, 9, 8, 7, 6, 5, 4, 3, or 2 carbon atoms. In some embodiments, the cation is a tetramethylammonium or a tetrabutylphosphonium. In some embodiments, the cation is tetrabutylphosphonium.

In some embodiments, the curative composition according to the present disclosure includes at least one of tetramethylammonium perfluoro-tert-butoxide or tetrabutylphosphonium perfluoro-tert-butoxide. In some embodiments, the curative composition according to the present disclosure includes tetramethylammonium perfluoro-tert-butoxide. In some embodiments, the curative composition according to the present disclosure includes tetrabutylphosphonium perfluoro-tert-butoxide.

The curative composition according to the present disclosure can be prepared, for example, by reacting an alcohol represented by Formula (Rf)₃C—OH with a base, such as a tetraalkylphosphonium or tetraalkylammonium hydroxide in a suitable solvent optionally containing water. The alcohol represented by Formula (Rf)₃C—OH may alternatively be reacted with a metal hydroxide or alkoxide, such as sodium methoxide, and adding a tetraalkylphosphonium or tetraalkylammonium halide, such as a tetraalkylphosphonium or tetraalkylammonium chloride or bromide, in a solvent and optionally precipitating the resulting halide salt. In the alcohol represented by Formula (Rf)₃C-OH, Rf is as defined in any of the embodiments described above. Some alcohols represented by Formula (Rf)₃C-OH are commercially available. Others can be made by known methods, for example, by reacting a perfluorinated ketone (e.g., hexafluoroacetone) with a suitable nucleophilic reagent.

In these methods of preparing the curative composition according to the present disclosure, the solvent may be essentially free of hydrocarbon alcohols. The term “essentially free” as used herein means less than 5 wt % of hydrocarbon alcohol based on the total weight of the curative composition, in some embodiments, less than 1 wt % of hydrocarbon alcohol based on the total weight of the curative composition, and in some embodiments, less than 0.1 wt % of hydrocarbon alcohol based on the total weight of the curative composition. The term “hydrocarbon alcohol” as used herein refers to an alcohol that has only hydrogen or carbon substituents on the hydroxyl bearing carbon. Examples include ethanol, methanol, propanols, ethylene glycol, and 2-methoxy ethanol. The solvent may also be essentially free of alcohols including halogen atoms at least 2 carbon atoms away from the hydroxyl bearing carbon. As suggested in Int. Pat. Appl. Pub. No. WO 2010/151610 (Grootaert et al.), preparing the curative composition according to the present disclosure in a reaction medium that is essentially free of hydrocarbon alcohols may be useful for eliminating premature curing during processing, often referred to as “scorch”. A curative composition essentially free of hydrocarbon alcohol according to the present disclosure may be obtained by vacuum stripping a hydrocarbon alcohol from the curative composition if the hydrocarbon alcohol is present during the preparation of the curative composition.

The curative composition according to the present disclosure may also be prepared in situ, such as by reacting one or more alcohols represented by Formula (Rf)₃C—OH and a tetraalkylphosphonium or tetraalkylammonium chloride or bromide, for example, with a suitable base in a composition without isolating the salt. Accordingly, in some embodiments, the curative composition disclosed herein may further comprise an organic or inorganic base. Examples of suitable bases include Ca(OH)₂, MgO, and combinations thereof. Further, the precursors to the curative composition may be provided into a fluoropolymer composition, such that the curative composition forms in situ and/or such that the effective components of the curative arise during typical fluoropolymer operations such as milling a fluoroelastomer. More particularly, the precursor materials leading to the curative composition can be combined by adding the cation component(s) and/or the alcohol represented by Formula (Rf)₃C-OH separately into the fluoropolymer composition.

The curative compositions disclosed herein are useful, for example, in fluoropolymer compositions. In some embodiments, the fluoropolymer composition includes an amorphous, curable fluoropolymer having nitrogen-containing cure sites. Suitable amorphous fluoropolymers having nitrogen-containing cure sites typically comprise interpolymerized monomer units derived from at least one, more typically at least two, principal monomers and a nitrogen-containing monomer. Examples of suitable principal monomers include perfluoroolefins (e.g., tetrafluoroethylene (TFE) and hexafluoropropylene (HFP), or any perfluoroolefin of the formula CF₂═CF—Rf, where Rf is fluorine or a perfluoroalkyl of 1 to 8, in some embodiments 1 to 3, carbon atoms), halogenated fluoroolefins (e.g., trifluorochloroethylene (CTFE)), perfluorovinyl ethers (e.g., perfluoroalkyl vinyl ethers (PAVE) and perfluoroalkoxyalkyl vinyl ethers (PAAVE)), and hydrogen-containing monomers such as olefins (e.g., ethylene, propylene, or another non-fluorinated alpha-olefin such as a C₂ to C₉ alpha olefin) and partially fluorinated olefins (e.g., vinylidene fluoride (VDF), pentafluoropropylene, trifluoroethylene, or an olefin in which less than half or less than one-fourth of the hydrogen atoms are replaced with fluorine). Examples of such amorphous fluoropolymers include, for example, those referred to in the art as “fluoroelastomer gums” and “perfluoroelastomer gums”. In some embodiments, the fluoropolymer comprises interpolymerized units of tetrafluoroethylene and at least one of a different perfluorinated olefin, a partially fluorinated olefin, a non-fluorinated olefin, a perfluoroalkylvinylether, or a perfluoroalkoxyvinylether. Those skilled in the art are capable of selecting specific interpolymerized units at appropriate amounts to form a fluoroelastomer.

In some embodiments, halogen- or hydrogen-containing olefins useful as monomers in the amorphous fluoropolymer include those of the formula CX₂═CX—R, wherein each X is independently hydrogen, fluoro, or chloro and R is hydrogen, fluoro, or a C₁-C₁₂, in some embodiments C₁-C₃, alkyl, with the proviso that not all X and R groups are fluoro groups. In some embodiments, polymerized units derived from non-fluorinated olefin monomers are present in the amorphous fluoropolymer at up to 25 mole percent of the fluoropolymer, in some embodiments up to 10 mole percent or up to 3 mole percent.

Suitable perfluorinated ethers include PAAVE of the formula CF₂═CF—ORf , wherein Rf is a linear, branched, or cyclic perfluorinated alkyl group optionally containing ether linkages, and CF₂═CFO—(CF₂)ₘ—(O(CF₂)ₚ)ₙ—ORf, wherein Rf is a perfluorinated (C₁-C₄) alkyl group, m is 1 to 4, n is 0 to 6, and p is 1 to 2. Such perfluorinated ethers are described, for example, in U.S. Pat. Nos. 6,255,536 and 6,294,627 (each to Worm et al.) Examples of suitable PAAVE include CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂ CF₂OCF₃, CF₂═CFOCF₂OCF₂CF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃, CF₂═CFOCF₂CF₂OCF₂CF₂CF₃, CF₂═CFOCF₂CF₂OCF₂CF₂OCF₂CF₂CF₃, CF₂═CF—O—CF₂CF(CF₃)—O—CF₃, CF₂═CFOCF₂CF(CF₃)OCF₂CF₂CF₃, and CF₂═CFOCF₂CF(CF₃)OCF₂CF(CF₃)OCF₂CF₂CF₃. Examples of suitable PAVE include CF₂═CFOCF₃ and CF₂═CFOCF₂CF₂CF₃. Mixtures of PAVE and PAAVE may also be employed. In addition, the amorphous fluoropolymers may include interpolymerized units of fluoro (alkene ether) monomers, including those described in U.S. Pat. Nos. 5,891,965 (Worm et al.) and 6,255,535 (Schulz et al.). Such monomers include those represented by formula CF₂═CF(CF₂)ₘ—O—R_{f}, wherein m is an integer from 1 to 4, and wherein R_{f} is a linear or branched perfluoroalkylene group that may include oxygen atoms thereby forming additional ether linkages, and wherein R_{f} contains from 1-20, in some embodiments from 1 to 10, carbon atoms in the backbone, and wherein R_{f} also may contain additional terminal unsaturation sites. In some embodiments, m is 1. Examples of suitable fluoro (alkene ether) monomers include perfluoroalkoxyalkyl allyl ethers such as CF₂═CFCF₂—O—CF₃, CF₂═CFCF₂-O—CF₂—O—CF₃, CF₂═CFCF₂—O—CF₂CF₂—O—CF₃, CF₂═CFCF₂—O—CF₂CF₂—O—CF₂—O—O—CF₂CF₃, CF₂═CFCF₂—O—CF₂CF₂—O—CF₂CF₂CF₂—O—CF₃, CF₂═CFCF₂—O—CF₂CF₂—O—CF₂CF₂—O—CF₂—OCF₃, CF₂═CFCF₂CF₂—O—CF₂CF₂CF₃. Perfluorinated ethers are typically liquids and may be pre-emulsified with an emulsifier before its copolymerization with the other comonomers, for example, addition of a gaseous fluoroolefin. In some embodiments, polymerized units derived from at least one of PAVE or PAAVE monomers are present in the amorphous fluoropolymer at up to 50 mole percent of the fluoropolymer, in some embodiments up to 30 mole percent or up to 10 mole percent.

If the amorphous fluoropolymer is perhalogenated, in some embodiments perfluorinated, typically at least 50 mole percent (mol %) of its interpolymerized units are derived from TFE and/or CTFE, optionally including HFP. The balance of the interpolymerized units of the amorphous fluoropolymer (e.g., 10 to 50 mol %) is made up of one or more perfluoroalkyl vinyl ethers and/or perfluoroalkoxy vinyl ethers, and a nitrogen-containing cure site monomer. If the fluoropolymer is not perfluorinated, it typically contains from about 5 mol % to about 90 mol % of its interpolymerized units derived from TFE, CTFE, and/or HFP; from about 5 mol % to about 90 mol % of its interpolymerized units derived from VDF, ethylene, and/or propylene; up to about 40 mol % of its interpolymerized units derived from a vinyl ether; and from about 0.1 mol % to about 5 mol %, in some embodiments from about 0.3 mol % to about 2 mol %, of a nitrogen-containing cure site monomer.

Examples of amorphous fluoropolymers useful for practicing the present disclosure include a

TFE/propylene copolymer, a TFE/propylene/VDF copolymer, a VDF/HFP copolymer, a TFE/VDF/HFP copolymer, a TFE/perfluoromethyl vinyl ether (PMVE) copolymer, a TFE/CF₂═CFOC₃F₇ copolymer, a TFE/CF₂═CFOCF₃/CF₂═CFOC₃F₇ copolymer, a TFE/CF₂⊚COC₂F₅ copolymer, a TFE/ethyl vinyl ether (EVE) copolymer, a TFE/butyl vinyl ether (BVE) copolymer, a TFE/EVE/BVE copolymer, a VDF/CF₂═CFOC₃F₇ copolymer, an ethylene/HFP copolymer, a TFE/ HFP copolymer, a CTFE/VDF copolymer, a TFE/VDF copolymer, a TFE/VDF/PMVE/ethylene copolymer, and a TFE/VDF/CF₂═CFO(CF₂)₃0CF₃ copolymer, each of which copolymers may also contain a monomeric unit having a nitrogen-containing cure site.

Nitrogen-containing cure sites enable curing the amorphous fluoropolymer to form the fluoroelastomer composition. At least one cure site component of at least one fluoropolymer comprises a nitrogen-containing group. Examples of monomers comprising nitrogen-containing groups useful in preparing fluoropolymers comprising a nitrogen-containing cure sites include free-radically polymerizable nitriles, imidates, amidines, amides, imides, and amine-oxides. Mixtures of any of these nitrogen-containing cure sites may be useful in the fluoropolymer compositions according to the present disclosure. Useful nitrogen-containing cure site monomers include nitrile-containing fluorinated olefins and nitrile-containing fluorinated vinyl ethers, for example, CF₂═CFO(CF₂)_{L}CN, CF₂═CFO(CF₂)ᵤOCF(CF₃)CN, CF₂═CFO[CF₂CF(CF₃)O]_{q}(CF₂O)_{y}CF(CF₃)CN, or CF₂═CF[OCF₂CF(CF₃)],O(CF₂)ₜCN, wherein L is in a range from 2 to 12; u is in a range from 2 to 6; q is in a range from 0 to 4; y is in a range from 0 to 6; r is in a range from 1 to 2; and t is in a range from 1 to 4. Examples of such monomers include CF₂═CFO(CF₂)₃OCF(CF₃)CN, perfluoro(8-cyano-5-methyl-3,6-dioxa-1-octene), and CF₂═CFO(CF₂)₅CN.

Nitrogen-containing cure sites can also be incorporated into the amorphous fluoropolymer by employing selected chain transfer agents (e.g., I(CF₂)_{d}CN in which d is 1 to 10 or 1 to 6) or by carrying out the free-radical polymerization in the presence of a perfluorosulfinate such as NC(CF₂)_{d}SO₂G, in which G represents a hydrogen atom or a cation with valence of 1 or 2.

The nitrogen-containing monomer, chain transfer agent, and/or initiator typically makes up about 0.1 to 5 mole percent (in some embodiments, 0.3 to 2 mole percent) of the polymerization components.

The amorphous fluoropolymer presently disclosed is typically prepared by a sequence of steps, which can include polymerization, coagulation, washing, and drying. In some embodiments, an aqueous emulsion polymerization can be carried out continuously under steady-state conditions. For example, an aqueous emulsion of monomers (e.g,. including any of those described above), water, emulsifiers, buffers and catalysts can be fed continuously to a stirred reactor under optimum pressure and temperature conditions while the resulting emulsion or suspension is continuously removed. In some embodiments, batch or semibatch polymerization is conducted by feeding the aforementioned ingredients into a stirred reactor and allowing them to react at a set temperature for a specified length of time or by charging ingredients into the reactor and feeding the monomers into the reactor to maintain a constant pressure until a desired amount of polymer is formed. After polymerization, unreacted monomers are removed from the reactor effluent latex by vaporization at reduced pressure. The amorphous fluoropolymer can be recovered from the latex by coagulation.

The polymerization is generally conducted in the presence of a free radical initiator system, such as ammonium persulfate, potassium permanganate, AIBN, or bis(perfluoroacyl) peroxides. The polymerization reaction may further include other components such as chain transfer agents and complexing agents. The polymerization is generally carried out at a temperature in a range from 10° C. and 100° C., or in a range from 30° C. and 80° C. The polymerization pressure is usually in the range of 0.3 MPa to 30 MPa, and in some embodiments in the range of 2 MPa and 20 MPa.

When conducting emulsion polymerization, perfluorinated or partially fluorinated emulsifiers may be useful. Generally these fluorinated emulsifiers are present in a range from about 0.02% to about 3% by weight with respect to the polymer. Polymer particles produced with a fluorinated emulsifier typically have an average diameter, as determined by dynamic light scattering techniques, in range of about 10 nanometers (nm) to about 300 nm, and in some embodiments in range of about 50 nm to about 200 nm. If desired, the emulsifiers can be removed or recycled from the fluoropolymer latex as described in U.S. Pat. Nos. 5,442,097 to Obermeier et al., 6,613,941 to Felix et al., 6,794,550 to Hintzer et al., 6,706,193 to Burkard et al. and 7,018,541 Hintzer et al. In some embodiments, the polymerization process may be conducted with no emulsifier (e.g., no fluorinated emulsifier). Polymer particles produced without an emulsifier typically have an average diameter, as determined by dynamic light scattering techniques, in a range of about 40 nm to about 500 nm, typically in range of about 100 nm and about 400 nm, and suspension polymerization will typically produce particles sizes up to several millimeters.

In some embodiments, a water soluble initiator can be useful to start the polymerization process. Salts of peroxy sulfuric acid, such as ammonium persulfate, are typically applied either alone or sometimes in the presence of a reducing agent, such as bisulfites or sulfinates (disclosed in U.S. Pat. Nos. 5,285,002 and 5,378,782 both to Grootaert) or the sodium salt of hydroxy methane sulfinic acid (sold under the trade designation “RONGALIT”, BASF Chemical Company, New Jersey, USA). Most of these initiators and the emulsifiers have an optimum pH-range where they show most efficiency. For this reason, buffers are sometimes useful. Buffers include phosphate, acetate or carbonate buffers or any other acid or base, such as ammonia or alkali metal hydroxides. The concentration range for the initiators and buffers can vary from 0.01% to 5% by weight based on the aqueous polymerization medium. If desired, such as for improved processing, the presence of strong polar end groups such as SO₃⁽⁻⁾ and COO⁽⁻⁾ can be reduced through known post treatments (e.g., decarboxylation, post-fluorination). Chain transfer agents of any kind can significantly reduce the number of ionic or polar end groups.

The chain transfer agents having the cure site and/or the cure site monomers can be fed into the reactor by batch charge or continuously feeding. Because feed amount of chain transfer agent and/or cure site monomer is relatively small compared to the monomer feeds, continuous feeding of small amounts of chain transfer agent and/or cure site monomer into the reactor can be achieved by blending the nitrogen-containing monomer or chain transfer agent in one or more monomers. Examples of monomers useful for such a blend include HFP and PMVE.

Adjusting, for example, the concentration and activity of the initiator, the concentration of each of the reactive monomers, the temperature, the concentration of the chain transfer agent, and the solvent using techniques known in the art can control the molecular weight of the amorphous fluoropolymer. In some embodiments, amphorphous fluoropolymers useful for practicing the present disclosure have weight average molecular weights in a range from 10,000 grams per mole to 200,000 grams per mole. In some embodiments, the weight average molecular weight is at least 15,000, 20,000, 25,000, 30,000, 40,000, or 50,000 grams per mole up to 100,000, 150,000, 160,000, 170,000, 180,000, or up to 190,000 grams per mole. Amorphous fluoropolymers disclosed herein typically have a distribution of molecular weights and compositions. Weight average molecular weights can be measured, for example, by gel permeation chromatography (i.e., size exclusion chromatography) using techniques known to one of skill in the art.

While —CN cure sites are useful in the fluoropolymer compositions according to the present disclosure, other nitrogen-containing cure sites may also be useful. After polymerization, the polymer may be reacted with alcohols to transform the —CN cure sites into C-alkoxycarbonimidoyl cure sites (that is, —C(═NH)—O—R⁵, wherein R5 is alkyl having from 1 to 10, in some embodiments, 1 to 4, carbon atoms, in which some of the hydrogen atoms may be replaced by fluorine atoms). The reaction can conveniently be carried out by combining the polymer with the alcohol or mixture of alcohols in the presence of a base at ambient temperatures. The corresponding salt(s) of the selected alcohol or amines are useful bases for the reaction. Further details may be found, for example, in U.S. Pat. No. 6,803,425 (Hintzer et al.). Amidines, which may be obtained by reacting the —CN containing polymer with an amine, are also useful cure sites.

To coagulate the obtained amorphous fluoropolymer latex, any coagulant which is commonly used for coagulation of a fluoropolymer latex may be used, and it may, for example, be a water soluble salt (e.g., calcium chloride, magnesium chloride, aluminum chloride or aluminum nitrate), an acid (e.g., nitric acid, hydrochloric acid or sulfuric acid), or a water-soluble organic liquid (e.g., alcohol or acetone). The amount of the coagulant to be added may be in range of 0.001 to 20 parts by mass, for example, in a range of 0.01 to 10 parts by mass per 100 parts by mass of the amorphous fluoropolymer latex. Alternatively or additionally, the amorphous fluoropolymer latex may be frozen for coagulation. The coagulated amorphous fluoropolymer can be collected by filtration and washed with water. The washing water may, for example, be ion exchanged water, pure water or ultrapure water. The amount of the washing water may be from 1 to 5 times by mass to the amorphous fluoropolymer, whereby the amount of the emulsifier attached to the amorphous fluoropolymer can be sufficiently reduced by one washing.

The amorphous fluoropolymers useful for some embodiments of the fluoropolymer compositions according to the present disclosure may include a blend of fluoropolymers. Two or more different amorphous fluoropolymers each having interpolymerized units derived from a nitrogen-containing cure site monomer may be useful. One or more other amorphous fluoropolymers or copolymers may be blended with the amorphous fluoropolymer having interpolymerized units derived from a nitrogen-containing cure site monomer. Examples of useful other amorphous fluoropolymers for blending include homopolymers and copolymers comprising any of the interpolymerized units mentioned above, but they may lack interpolymerized units derived from a nitrogen-containing cure site monomer and/or may include reactive sites adapted to a selected curative system. The amorphous fluoropolymer having interpolymerized units derived from a nitrogen-containing cure site monomer or the mixture of such amorphous fluoropolymers are typically present in the blend at least at 25 weight percent (wt %), in some embodiments, at least 50 wt %, of the total fluoropolymer in the fluoropolymer composition. In some embodiments, the fluoropolymer in the fluoropolymer composition is comprised entirely of one of more amorphous fluoropolymers with nitrogen-containing interpolymerized units. An amorphous fluoropolymer that has interpolymerized units derived from a nitrogen-containing cure site monomer may have interpolymerized units derived from other types of cure site monomers. For example, an amorphous fluoropolymer according to the present disclosure can contain nitrogen-containing cure site and a halogen that is capable of participation in a peroxide cure reaction.

Peroxide-curable amorphous fluoropolymers typically include a chloro, bromo-, or iodo-cure site. In some embodiments, the amorphous fluoropolymer in the fluoropolymer composition according to the present disclosure, which may include one amorphous fluoropolymer or a blend of fluoropolymers, comprises a bromo- or iodo-cure site. In some of these embodiments, the amorphous fluoropolymer comprises an iodo-cure site. The cure site can be an iodo-, bromo-, or chloro-group chemically bonded at the end of a fluoropolymer chain or may be present along the fluoropolymer chain. The weight percent of elemental iodine, bromine, or chlorine in the amorphous fluoropolymer may range from about 0.2 wt. % to about 2 wt. %, and, in some embodiments, from about 0.3 wt.% to about 1 wt. %. To incorporate a cure site end group into the amorphous fluoropolymer, any one of an iodo-chain transfer agent, a bromo-chain transfer agent or a chloro-chain transfer agent can be used in the polymerization process. For example, suitable iodo-chain transfer agents include perfluoroalkyl or chloroperfluoroalkyl groups having 3 to 12 carbon atoms and one or two iodo- groups. Examples of iodo-perfluoro-compounds include 1,3-diiodoperfluoropropane, 1,4-diiodoperfluorobutane, 1, 6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutane and mixtures thereof. Suitable bromo-chain transfer agents include perfluoroalkyl or chloroperfluoroalkyl groups having 3 to 12 carbon atoms and one or two iodo- groups. Chloro-, bromo-, and iodo- cure sites may also be incorporated into the amorphous fluoropolymer by including cure site monomers in the polymerization reaction. Examples of cure site monomers include those of the formula CX₂═CX(Z), wherein each X is independently H or F, and Z is I, Br, or R_{f}—Z, wherein Z is I or Br and R_{f} is a perfluorinated or partially perfluorinated alkylene group optionally containing O atoms. In addition, non-fluorinated bromo-or iodo-substituted olefins, e.g., vinyl iodide and allyl iodide, can be used. In some embodiments, the cure site monomer is CH₂═CHI, CF₂═CHI, CF₂═CFI, CH₂═CHCH₂I, CF₂═CFCF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, CF₂═CFCl, CF₂═CFCF₂Cl, or a mixture thereof.

Generally, a total of from about 0.1 to about 5 mol % (in some embodiments from about 0.3 to about 2 mol %) cure site monomeric units, which may have different types of cure sites, is incorporated into the amorphous fluoropolymer.

Any effective amount of the curative composition according to the present disclosure may be used to crosslink the fluoropolymer composition according to the present disclosure. The amount of the curative composition may be selected such that the fluoropolymer crosslinks to a sufficient extent to develop the desired physical properties and/or at a desirable rate for a particular process. Various components in a fluoropolymer composition may also affect the amount of curative composition desired. For example, the type and/or amount of filler selected may retard or accelerate curing relative to a similar, but unfilled, composition, requiring an appropriate adjustment in the amount of curative composition. The composition of the amorphous fluoropolymer also affects the effective amount of the curative composition according to the present disclosure. For example, when a blend of an amorphous fluoropolymer with interpolymerized units of a nitrogen-containing cure site monomer and another amorphous fluoropolymer having halogen cure sites is used, an effective amount of the curative composition according to the present disclosure can be used to crosslink the fluoropolymer having interpolymerized units derived from a nitrogen-containing cure site monomer together with an effective amount of a second curative used to crosslink the other fluoropolymer. Also, when an amorphous fluoropolymer includes both nitrogen-containing cure sites and other cure sites, a combination of the curative composition according to the present disclosure and the second curative may be useful. Generally, an effective amount of the curative composition in combination with any second curative is at least about 0.1 parts curative per hundred parts of gum on a weight basis (phr), in some embodiments at least about 0.5 phr. The effective amount of curative generally is below about 10 phr, in some embodiments, below about 5 phr.

In embodiments in which the amorphous polymer contains a chloro, bromo-, or iodo-cure site in addition to a nitrogen-containing cure site as described above, fluoropolymer compositions according to the present disclosure typically include a peroxide along with a curative composition according to the present disclosure. Suitable peroxides are generally those which generate free radicals at curing temperatures. Dialkyl peroxides and bis(dialkyl peroxides), each of which decomposes at a temperature above 50° C., may be useful. Examples of useful peroxides include 2,5-dimethyl-2,5-di(t-butylperoxy)hexyne-3, 2,5-dimethyl-2,5-di(t-butylperoxy)hexane, dicumyl peroxide, t-butyl perbenzoate, a,a′-bis(t-butylperoxy-diisopropylbenzene), and di[1,3-dimethyl-3-(t-butylperoxy)-butyl]carbonate. Acyl peroxides tend to decompose at lower temperatures than alkyl peroxides and allow for lower temperature curing. Examples of useful acyl peroxides include di(4-t-butylcyclohexyl)peroxydicarbonate, di(2-phenoxyethyl)peroxydicarbonate, di(2,4-dichlorobenzoyl) peroxide, dilauroyl peroxide, decanoyl peroxide, 1,1,3,3-tetramethylethylbutylperoxy-2-ethylhexanoate, 2,5-dimethyl-2,5-di(2-ethylhexanoylperoxy)hexane, disuccinic acid peroxide, t-hexyl peroxy-2-ethylhexanoate, di(4-methylbenzoyl) peroxide, t-butyl peroxy-2-ethylhexanoate, benzoyl peroxide, t-butylperoxy 2-ethylhexyl carbonate, and t-butylperoxy isopropyl carbonate.

Furthermore, in peroxide-cured fluoroelastomers, it is often desirable to include a crosslinker. The crosslinkers may be useful, for example, for providing enhanced mechanical strength in the final cured composition. Examples of useful crosslinkers include tri(methyl)allyl isocyanurate (TMAIC), triallyl isocyanurate (TAILC), tri(methyl)allyl cyanurate, poly-triallyl isocyanurate (poly-TAIC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, and CH₂═CH—R_{f1}—CH═CH₂, wherein R_{f1} is a perfluoroalkylene having from 1 to 8 carbon atoms. The crosslinker is typically present in an amount of 1% by weight to 10% by weight versus the weight of the fluoropolymer composition. In some embodiments, the crosslinker is present in a range from 2% by weight to 5% by weight versus the weight of the fluoropolymer composition.

Curing of the fluoropolymer composition according to the present disclosure, wherein the amorphous fluoropolymer has nitrogen-containing cure sites, can also be modified by using yet other types of curatives in addition to the curative composition according to the present disclosure. Examples of such curatives for amorphous fluoropolymers with nitrile cure sites include bis-aminophenols (e.g., U.S. Pat. Nos. 5,767,204 (Iwa et al.) and 5,700,879 (Yamamoto et al.)), bis-amidooximes (e.g., U.S. Pat. No. 5,621,145 (Saito et al.)), and ammonium salts (e.g., U.S. Pat. No. 5,565,512 (Saito et al.)). In addition, organometallic compounds of arsenic, antimony, and tin (e.g., allyl-, propargyl-, triphenyl-allenyl-, and tetraphenyltin and triphenyltin hydroxide) as described in U.S. Pat. Nos. 4,281,092 (Breazeale) and 5,554,680 (Ojakaar) and ammonia-generating compounds may be useful. “Ammonia-generating compounds” include compounds that are solid or liquid at ambient conditions but that generate ammonia under conditions of cure. Examples of such compounds include hexamethylenetetramine (urotropin), dicyandiamide, and metal-containing compounds of the formula A^{w+} (NH₃)ₓY^{w-}, wherein A^{w+} is a metal cation such as Cu²⁺, Co²⁺, Co³⁺, Cu⁺, and Ni²⁺; w is equal to the valance of the metal cation; Y^{w-} is a counterion (e.g., a halide, sulfate, nitrate, acetate); and x is an integer from 1 to about 7. Further examples include substituted and unsubstituted triazine derivatives such as those of the formula:

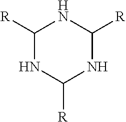

wherein R is a hydrogen atom or a substituted or unsubstituted alkyl, aryl, or aralkyl group having from 1 to about 20 carbon atoms. Specific useful triazine derivatives include hexahydro-1,3,5-s-triazine and acetaldehyde ammonia trimer.

The combination of curative(s) is generally from about 0.01 to about 10 mol % (in some embodiments, from about 0.1 to about 5 mol %) of the total fluoropolymer amount.

Additives such as carbon black, stabilizers, plasticizers, lubricants, fillers, and processing aids typically utilized in fluoropolymer compounding can be incorporated into the curative compositions and fluroopolymer compositions according to the present disclosure, provided they have adequate stability for the intended service conditions. In particular, low temperature performance can be enhanced by incorporation of perfluoropolyethers as described for example, U.S. Pat. No. 5,268,405 (Ojakaar et al.) Silica and/or carbon black fillers can be employed in fluoropolymers as a means to balance modulus, tensile strength, elongation, hardness, abrasion resistance, conductivity, and processability of the compositions. Suitable examples include fumed silica, for example, fumed silica commercially available under the trade designation “AEROSIL” from Degussa AG. Suitable examples of carbon black fillers include MT blacks (medium thermal black designated N-991, N-990, N-908, and N-907; FEF N-550) and large particle size furnace blacks. When used, 1 to 100 parts filler per hundred parts fluoropolymer (phr) is generally sufficient.

Fluoropolymer fillers may also be present in the curable compositions and fluoropolymer compositions according to the present dislcosure. Generally, from 1 to 100 phr of fluoropolymer filler per hundred parts fluoropolymer is used. The fluoropolymer filler can be finely divided and easily dispersed as a solid at the highest temperature used in fabrication and curing of the inventive composition. By solid, it is meant that the filler material, if at least partially crystalline, will have a crystalline melting temperature above the processing temperature(s) of the fluoropolymer composition(s). One way to incorporate fluoropolymer filler is by blending latices. This procedure, using various kinds of fluoropolymer filler, is described in U.S. Pat. No. 6,720,360 (Grootaert et al.).

Alternatively, in some embodiments, including any of the embodiments of the fluoropolymer composition disclosed herein, the fluoropolymer composition according to the present disclosure is free of fillers (e.g., inorganic fillers) or contains less than 5%, 2%, or 1% by weight fillers (e.g., inorganic fillers) versus the weight of the fluoropolymer composition. One advantage to avoiding fillers in the curable compositions disclosed herein is that visible light transmissive cured fluoroelastomers may be obtained.

Conventional adjuvants may also be incorporated into the fluoropolymer composition disclosed herein to enhance the properties of the fluoroelastomer. For example, acid acceptors may be employed to facilitate the cure and enhance the thermal stability of the fluoroelastomer, for example, by binding HF or any other acids that may be generated during cure or use. Suitable acid acceptors may include magnesium oxide, lead oxide, calcium oxide, calcium hydroxide, dibasic lead phosphite, zinc oxide, barium carbonate, strontium hydroxide, calcium carbonate, hydrotalcite, alkali stearates, magnesium oxalate, silicon dioxide, or combinations thereof. The acid acceptors can be used in amounts ranging from about 1 to about 20 parts per 100 parts by weight of the amorphous fluoropolymer. However, some applications like fuel cell sealants or gaskets require low metal content. Accordingly, in some embodiments, the fluoropolymer composition is free of such adjuvants or includes less than 0.5% by weight of such adjuvants versus the weight of the fluoropolymer composition.

Fluoropolymer compositions according to the present disclosure can be prepared by mixing the curable composition according to the present disclosure, amorphous fluoropolymer, which may include more than one fluoropolymer, and any desired additional curatives, additives, crosslinkers, or adjuvants as described above. The components can be compounded on conventional rubber processing equipment, for example. Compounding can be carried out, for example, on a roll mill (e.g., two-roll mill), internal mixer (e.g., Banbury mixers), or other rubber-mixing device. Thorough mixing is typically desirable to distribute the components and additives uniformly throughout the fluoropolymer composition so that it can cure effectively. The compounding can be carried out in one or several steps. It is typically desirable that the temperature of the composition during mixing should not rise high enough to initiate curing. For example, the temperature of the composition may be kept at or below about 120° C., 100° C., or 80° C.

The mixture is then processed and shaped, such as by extrusion (e.g., into the shape of a film, tube, or hose) or by molding (e.g., in the form of sheet or an O-ring). The shaped article can then be heated to cure the fluoropolymer composition and form a cured article. Molding or press curing of the compounded mixture usually is conducted at a temperature sufficient to cure the mixture in a desired time duration under a suitable pressure. Generally, this is between about 95° C. and about 230° C., in some embodiments, between about 150° C. and about 205° C., for a period of from about 1 minute to 15 hours, typically from 5 minutes to 30 minutes. A pressure of between about 700 kPa and about 21,000 kPa is usually imposed on the compounded mixture in a mold. The molds may be first coated with a release agent and baked. The cure time may depend on the composition of the amorphous fluoropolymer and the cross-sectional thickness of the cured fluoroelastomer.

The molded mixture or press-cured article is then usually post-cured (e.g., in an oven) at a temperature and for a time sufficient to complete the curing, usually between about 150° C. and about 300° C., typically at about 230° C., for a period of from about 2 hours to 50 hours or more, generally increasing with the cross-sectional thickness of the article. For thick sections, the temperature during the post cure is usually raised gradually from the lower limit of the range to the desired maximum temperature. The maximum temperature used is typically about 300° C., and this temperature is held for about 4 hours or more. The post-cure step generally completes the cross-linking and may also release residual volatiles from the cured compositions. One example of a suitable post-cure cycle involves exposing molded parts to heat under nitrogen using six stages of conditions. First, the temperature is increased from 25° C. to 200° C. over 6 hours, then the parts are held at 200° C. for 16 hours, after which the temperature is increased from 200° C. to 250° C. over 2 hours. Then the parts are held at 250° C. for 8 hours, after which the temperature is increased from 250° C. to 300° C. over 2 hours. Then the parts are held at 300° C. for 16 hours. Finally, the parts are returned to ambient temperature such as by shutting off the oven heat.

The fluoropolymer composition according to the present disclosure can be used to make cured fluoroelastomers in the form of a variety of articles, including final articles, such as O-rings, gaskets, tubing, and seals, and/or preforms from which a final shape is made, (e.g. a tube from which a ring is cut). To form an article, the fluoropolymer composition can be extruded using a screw type extruder or a piston extruder. The extruded or pre-formed curable compositions can be cured in an oven at ambient pressure or under elevated pressure. A post-cure cycle may then be useful. The curable compositions formulated without inorganic acid acceptors are particularly well suited for applications such as seals and gaskets for manufacturing semiconductor devices, and in seals for high temperature automotive uses.

Alternatively, the fluoropolymer composition can be shaped into an article using injection molding, transfer molding, or compression molding. Injection molding of the fluoropolymer composition, for example, can be carried out by masticating the fluoropolymer composition in an extruder screw, collecting it in a heated chamber from which it is injected into a hollow mold cavity by means of a hydraulic piston. After vulcanization the article can then be demolded. Advantages of injection molding process include short molding cycles, little or no preform preparation, little or no flash to remove, and low scrap rate.

The fluoropolymer composition according to the present disclosure can also be used to prepare cure-in-place gaskets (CIPG) or form-in-place gaskets (FIPG). A bead or thread of the fluoropolymer composition can be deposited from a nozzle onto a substrates surface. After forming to a desired gasket pattern, the curable composition may be cured in place with a heat or in an oven at ambient pressure.

While tetramethylammonium 2-(p-toluyl)-1,1,1,3,3,3 hexafluroisopropoxide and tetrabutylphosphonium 2-(p-toluyl)-1,1,1,3,3,3 hexafluroisopropoxide have been shown to provide fluoroelastomers with very good compression set performance, curative compositions according to the present disclosure unexpectedly provide fluoroelastomers with even better compression set performance As shown in the Examples below, curative compositions according to the present disclosure provide fluoroelastomers with a compression set of up to 10 percent or even 15 percent lower than fluoroelastomers cured with tetramethylammonium 2-(p-toluyl)-1,1,1,3,3,3 hexafluroisopropoxide and tetrabutylphosphonium 2-(p-toluyl)-1,1,1,3,3,3 hexafluroisopropoxide when the fluoroelastomers are evaluated at 316° C. Furthermore, in many embodiments, curative compositions according to the present disclosure provide an unexpectedly advantageous cure rheology when compared to tetramethylammonium 2-(p-toluyl)-1,1,1,3,3,3 hexafluroisopropoxide and tetrabutylphosphonium 2-(p-toluyl)-1,1,1,3,3,3 hexafluroisopropoxide. Cure rheology can be measured on a rheometer as described in the Examples, below. Tan delta is calculated from the loss modulus (G″) divided by the storage modulus (G′) (tan δ=G″/G′). A higher tan delta indicates the fluoroelastomer is more fluid, and a lower tan delta indicates the fluoroelastomer is more elastic. The difference between maximum torque M_{H} as defined in the Examples and minimum torque M_{L} is related to crosslink density of cured fluoroelastomer. The time elapsed between the minimum torque value and the maximum torque value is an indication of processing time available before the fluoroelastomer is fully cured. The time for the torque to increase 2 units above M_{L} (t_{S}2), the time for the torque to reach a value equal to M_{L}+0.5(M_{H}−M_{L}), (t′50), and the time for the torque to reach M_{L}+0.9(M_{H}−M_{L}), (t′90) measured for the Examples and Comparative Examples below demonstrated that tetrabutylphosphonium perfluoro-tert-butoxide unexpectedly provided the highest processing window during the 30-minute evaluation time while providing the highest difference between the maximum torque and the minimum torque at the end of the 30-minute evaluation time.

### Some Embodiments of the Disclosure

In a first embodiment, the present disclosure provides a curative composition comprising a tetraalkylphosphonium or tetraalkylammonium cation and an anion represented by Formula

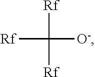

wherein each Rf is independently perfluoroalkyl having up to 12 carbon atoms.

In a second embodiment, the present disclosure provides the curative composition of the first embodiment, wherein each Rf is independently perfluoroalkyl having up to 4 carbon atoms. In a third embodiment, the present disclosure provides the curative composition of the first or second embodiment, wherein each Rf is perfluoromethyl.

In a fourth embodiment, the present disclosure provides the curative composition of any one of the first to third embodiments, wherein each alkyl independently has up to four carbon atoms.

In a fifth embodiment, the present disclosure provides the curative composition of any one of the first to fourth embodiments, wherein the tetraalkylphosphonium cation is tetrabutylphosphonium, and wherein the tetraalkylammonium cation is tetramethylammonium.

In a sixth embodiment, the present disclosure provides the curative composition of any one of the first to fifth embodiments, wherein the curative composition comprises at least one of tetramethylammonium perfluoro-tert-butoxide or tetrabutylphosphonium perfluoro-tert-butoxide.

In a seventh embodiment, the present disclosure provides the curative composition any one of the first to sixth embodiments, wherein the curative composition comprises tetramethylammonium perfluoro-tert-butoxide. In an alternative seventh embodiment, the curative composition comprises tetrabutylphosphonium perfluoro-tert-butoxide.

In an eighth embodiment, the present disclosure provides the curative composition of any one of the first to sixth embodiments, wherein the curative composition is essentially free of hydrocarbon alcohol.

In a ninth embodiment, the present disclosure provides a fluoropolymer composition comprising the curative composition of any one of the first to eighth embodiments and a fluoropolymer.

In a tenth embodiment, the present disclosure provides the fluoropolymer composition of the ninth embodiment, wherein the fluoropolymer is an amorphous, curable fluoropolymer with nitrogen-containing cure sites.

In an eleventh embodiment, the present disclosure provides the fluoropolymer composition of the ninth or tenth embodiment, wherein the nitrogen-containing cure sites are nitrile-containing cure sites.

In a twelfth embodiment, the present disclosure provides the fluoropolymer composition of any one of the ninth to eleventh embodiments, wherein the fluoropolymer comprises interpolymerized units of tetrafluoroethylene and at least one of a different perfluorinated olefin, a partially fluorinated olefin, a non-fluorinated olefin, a perfluoroalkylvinylether, or a perfluoroalkoxyalkylvinylether.

In a thirteenth embodiment, the present disclosure provides the fluoropolymer composition of the twelfth embodiment, wherein the interpolymerized units further comprise at least one of perfluoro(8-cyano-5-methyl-3,6-dioxa-1-octene), CF₂═CFO(CF₂)_{L}CN, CF₂═CFO(CF₂)ᵤOCF(CF₃)CN, CF₂═CFO[CF₂CF(CF₃)O]_{q}(CF₂O)_{y}CF(CF₃)CN, or CF₂═CF[OCF₂CF(CF₃)],O(CF₂),CN, wherein L is in a range from 2 to 12; u is in a range from 2 to 6; q is in a range from 0 to 4; y is in a range from 0 to 6; r is in a range from 1 to 2; and t is in a range from 1 to 4.

In a fourteenth embodiment, the present disclosure provides the fluoropolymer composition of any one of the ninth to thirteenth embodiments, further comprising at least one of a fluoropolymer filler, carbon black, or silica.

In a fifteenth embodiment, the present disclosure provides the fluoropolymer composition of any one of the ninth to fourteenth embodiments, further comprising at least one of an ammonia-generating compound, a substituted triazine derivative, an unsubstituted triazine derivative, a peroxide, a bis-aminophenol, a bis-amidooxime, an organotin compound, or an amidine, bis-amidine, tris-amidine, tetra-amidine, or a salt thereof.

In a sixteenth embodiment, the present disclosure provides a shaped article comprising the fluoropolymer composition of any one of the ninth to fifteenth embodiments.

In a seventeenth embodiment, the present disclosure provides a method of making a fluoroelastomer article comprising:

providing the fluoropolymer composition of any one of the ninth to fifteenth embodiments;

shaping the fluoropolymer composition; and

crosslinking the fluoropolymer composition to form the fluoroelastomer article.

In an eighteenth embodiment, the present disclosure provides a method of making the curative composition of any one of the first to eighth embodiments, the method comprising making the cation and the anion by combining an alcohol represented by formula (Rf)₃COH and a tetraalkyl phosphonium hydroxide or a tetraalkylammonium hydroxide; or combining an alcohol represented by formula (Rf)₃COH, a base, and a tetraalkylphosphonium halide or a tetraalkylammonium halide.

In a nineteenth embodiment, the present disclosure provides the method of the eighteenth embodiment, wherein either the alcohol represented by formula (Rf)₃COH and the tetraalkyl phosphonium or tetraalkylammonium hydroxide or a fluorinated alkoxide generated from the alcohol represented by formula (Rf)₃COH and the base and the tetraalkylphosphonium or tetraalkylammonium halide are combined in a composition comprising a fluoropolymer.

In a twentieth embodiment, the present disclosure provides the method of the eighteenth or nineteenth embodiments, wherein combining an alcohol represented by formula (Rf)₃COH and a tetraalkylphosphonium or tetraalkylammonium hydroxide or combining an alcohol represented by formula (Rf)₃COH, a base, and a tetraalkylphosphonium or tetraalkylammonium halide is carried out in a reaction medium that is essentially free of a hydrocarbon alcohol.

In order that this disclosure can be more fully understood, the following examples are set forth. It should be understood that these examples are for illustrative purposes only and are not to be construed as limiting this disclosure in any manner

### EXAMPLES

Unless otherwise noted, all parts, percentages, ratios, etc. in the examples and the rest of the specification are by weight.

These abbreviations are used in the following examples: phr=parts per hundred rubber, min =minute, hr=hour, ° C.=degrees Celsius, EX=example, CE=comparative example. TFE is tetrafluoroethylene, and PMVE is perfluoro(methyl vinyl ether).

### Materials

| | |
|---|---|
| “PFE 131 TZ” | Perfluoroelastomer commercially available from 3M Company, St. Paul, MN, |
| | containing TFE, PMVE and a nitrile containing cure site monomer |
| Silica | Hydrophobic fumed silica commercially available under the trade designation |
| | “AEROSIL R972” from Evonik Industries, Piscataway, NJ |
| N990 | Carbon black commercially available from Cabot, Boston, MA |
| Comparative Catalyst 1 | Tetramethylammonium 2-(p-toluyl-1,1,1,3,3,3 hexafluroisopropoxide |
| (CC1) | prepared as in WO2010151610 “Example Preparation of |
| | Tetrabutylphosphonium 2-(p-toluyl)-1,1,1,3,3,3 hexafluroisopropoxide |
| | (TBTHI2), CH₃C₆H₄C(CF₃)₂O⁻⁺P(C₄H₉)₄ without methanol” except using |
| | tetramethylammonium hydroxide instead of the tetrabutyl phosphonium |
| | hydroxide. |
| Comparative Catalyst 2 | Tetrabutylphosphonium 2-(p-toluyl)-1,1,1,3,3,3 hexafluroisopropoxide |
| (CC2) | prepared as in WO2010151610 “Example Preparation of |
| | Tetrabutylphosphonium 2-(p-toluyl)-1,1,1,3,3,3 hexafluroisopropoxide |
| | (TBTHI2), CH₃C₆H₄C(CF₃)₂O⁻⁺P(C₄H₉)₄ without methanol” |
| Catalyst Example 1 | Tetramethylammonium perfluoro t-butoxide prepared as in CC1 but using |
| (Cat. Ex. 1) | perfluoro t-butanol obtained from Alfa Aesar, Ward Hill, Mass., instead of 2- |
| | (p-toluyl)-1,1,1,3,3,3 hexafluroisopropanol. |
| Catalyst Example 2 | Perfluoro t-butoxide prepared as in CC2 but using perfluoro t-butanol instead |
| (Cat. Ex. 2) | of 2-(p-toluyl)-1,1,1,3,3,3 hexafluroisopropanol. |

### Cure Rheology

Cure rheology tests were carried out using uncured, compounded samples using a rheometer marketed under the trade designation Monsanto Moving Die Rheometer (MDR) Model 2000 by

Monsanto Company, Saint Louis, Mo., in accordance with ASTM D 5289-93a at 177° C. No pre-heat was used, and a 30 minute elapsed time and a 0.5 degree arc were used. Both the minimum torque (M_{L}) and highest torque attained during a specified period of time when no plateau or maximum torque (M_{H}) was obtained were measured. Also measured were the time for the torque to increase 2 units above M_{L} (t_{S}2), the time for the torque to reach a value equal to M_{L}+0.5(M_{H}−M_{L}), (t′50), and the time for the torque to reach M_{L}+0.9(M_{H}−M_{L}), (t′90) as well as the tan delta at M_{H}. Results are reported in Table 1.

### O-Ring Molding and Compression Set

O-rings having a cross-section thickness of 0.139 inch (3.5 mm) were molded (12 min cure at 177° C.) followed by a postcure in nitrogen according to the following ramp-up procedure: room temperature to 200° C. over 45 min, hold at 200° C. for 2 hrs, 200° C. to 250° C. over 30 min, hold at 250° C. for 2 hrs, 250° C. to 300° C. over 30 min, hold at 300° C. for 2 hrs, 300° C. to room temperature over 2 hrs. The O-rings were subjected to compression set testing according to ASTM 395-89 method B, with 25% initial deflection.

For each of Examples 1 and 2 (Ex. 1 and 2) and Comparative Examples A and B (CE A and B), the materials in phr shown in Table 1 were compounded on a two-roll mill. 1.5 phr of CC1 and Cat. Ex. 1 is equal to 4.5 millimoles (mmol) and 4.8 mmol, respectively. 0.83 phr of CC2 equals 1.6 mmol, and 0.7 phr of Cat. Ex. 2 equals 1.4 mmol Cure Rheology evaluations were carried out for each Example and Comparative Example using the test method described above. O-rings were molded, cured, and evaluated using the method “O-Ring Molding and Compression Set” as described above. The results are shown in Table 1, below.

TABLE 1

| Material | CEA | CEB | EX1 | EX2 |
|---|---|---|---|---|
| PFE 131 TZ | 100 | 100 | 100 | 100 |
| N990 | 20 | 20 | 20 | 20 |
| Silica | 2 | 2 | 2 | 2 |
| Catalyst CC1 | 1.5 | | | |
| Catalyst CC2 | | 0.83 | | |
| Catalyst Cat. Ex. 1 | | | 1.5 | |
| Catalyst Cat. Ex. 2 | | | | 0.7 |
| MDR (20 min @ 177° C.) | | | | |
| M_{L}, in-lb | 2.29 | 2.08 | 2.53 | 1.06 |
| (N-m) | | | | |
| M_{H}, in-lb | 13.23 | 13.41 | 13.82 | 12.47 |
| (N-m) | | | | |
| t_{S}2, min | 1.46 | 1.66 | 1.60 | 2.23 |
| t′50, min | 3.31 | 3.26 | 3.10 | 5.37 |
| t′90, min | 8.15 | 9.78 | 7.19 | 14.57 |
| Tandelta @ M_{L} | 0.825 | 0.740 | 0.794 | 1.019 |
| Tandelta @ M_{H} | 0.085 | 0.072 | 0.083 | 0.077 |
| Compression set % | 39 | 24 | 36 | 17 |
| (72 hrs @ 300° C.) | | | | |
| Compression set % | 46 | 33 | 31 | 24 |
| (72 hrs @ 316° C.) | | | | |

Various modifications and alterations of this disclosure may be made by those skilled the art without departing from the scope and spirit of the disclosure, and it should be understood that this disclosure is not to be unduly limited to the illustrative embodiments set forth herein.

1. A curative composition comprising a tetraalkylphosphonium or tetraalkylammonium cation and an anion represented by Formula 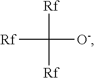
wherein each Rf is independently perfluoroalkyl having up to 12 carbon atoms.

2. The curative composition of claim 1, wherein each Rf is independently perfluoroalkyl having up to 4 carbon atoms.

3. The curative composition of claim 1, wherein each Rf is perfluoromethyl.

4. The curative composition of claim 1, wherein the tetraalkylphosphonium cation is tetrabutylphosphonium, and wherein the tetraalkylammonium cation is tetramethylammonium.

5. The curative composition of claim 1, wherein the curative composition comprises tetrabutylphosphonium perfluoro-tert-butoxide.

6. The curative composition of claim 1, wherein the curative composition is essentially free of hydrocarbon alcohol.

7. A fluoropolymer composition comprising the curative composition of claim 1 and a fluoropolymer.

8. The fluoropolymer composition of claim 7, wherein the fluoropolymer is an amorphous, curable fluoropolymer with nitrogen-containing cure sites.

9. The fluoropolymer composition of claim 8, wherein the nitrogen-containing cure sites are nitrile-containing cure sites.

10. The fluoropolymer composition of claim 7, wherein the fluoropolymer comprises interpolymerized units of tetrafluoroethylene and at least one of a different perfluorinated olefin, a partially fluorinated olefin, a non-fluorinated olefin, a perfluoroalkylvinylether, or a perfluoroalkoxyalkylvinylether.

11. The fluoropolymer composition of claim 10, wherein the interpolymerized units further comprise at least one of perfluoro(8-cyano-5-methyl-3,6-dioxa-1-octene), CF₂═CFO(CF₂)_{L}CN, CF₂═CFO(CF₂)ᵤOCF(CF₃)CN, CF₂═CFO[CF₂CF(CF₃)]_{q}(CF₂O)_{y}CF(CF₃)CN, or CF₂═CF[OCF₂CF(CF₃)]ᵣO(CF₂)CN, wherein L is in a range from 2 to 12; u is in a range from 2 to 6; q is in a range from 0 to 4; y is in a range from 0 to 6; r is in a range from 1 to 2; and t is in a range from 1 to 4.

12. The fluoropolymer composition of claim 7, further comprising at least one of a fluoropolymer filler, carbon black, or silica.

13. The fluoropolymer composition of claim 7, further comprising at least one of an ammonia-generating compound, a substituted triazine derivative, an unsubstituted triazine derivative, a peroxide, a bis-aminophenol, a bis-amidooxime, an organotin compound, or an amidine, bis-amidine, tris-amidine, tetra-amidine, or a salt thereof.

14. A shaped article comprising the fluoropolymer composition of claim 7.

15. A method of making a fluoroelastomer article comprising:
providing the fluoropolymer composition of claim 7, shaping the fluoropolymer composition; and
crosslinking the fluoropolymer composition to form the fluoroelastomer article.

16. A method of making the curative composition of claim 1, the method comprising making the cation and the anion by
combining an alcohol represented by formula (Rf)₃COH and a tetraalkyl phosphonium hydroxide or a tetraalkylammonium hydroxide; or
combining an alcohol represented by formula (Rf)₃COH, a base, and a tetraalkylphosphonium halide or a tetraalkylammonium halide.

17. The method of claim 18, wherein either the alcohol represented by formula (Rf)₃COH and the tetraalkyl phosphonium or tetraalkylammonium hydroxide or a fluorinated alkoxide generated from the alcohol represented by formula (Rf)₃COH and the base and the tetraalkylphosphonium or tetraalkylammonium halide are combined in a composition comprising a fluoropolymer.

18. The method of claim 18, wherein combining an alcohol represented by formula (Rf)₃COH and a tetraalkylphosphonium or tetraalkylammonium hydroxide or combining an alcohol represented by formula (Rf)₃COH, a base, and a tetraalkylphosphonium or tetraalkylammonium halide is carried out in a reaction medium that is essentially free of a hydrocarbon alcohol.

19. The curative composition of claim 1, wherein each alkyl independently has up to four carbon atoms.

20. The curative composition of claim 1, wherein the curative composition comprises tetramethylammonium perfluoro-tert-butoxide.
